(19) United States
(12) Patent Application Publication
(10) Pub. No.: US 2010/0004956 A1
(43) Pub. Date: Jan. 7, 2010

(54) SYSTEM AND METHOD FOR IMPROVED PATIENT CARE

(76) Inventors: William Jay MCCALLUM, Fort Worth, TX (US); Jack Edward MCCALLUM, Forth Worth, TX (US); Elisa Elizabeth MCALLISTER, Burleson, TX (US)

Correspondence Address: HITCHCOCK EVERT LLP, P.O. BOX 131709, DALLAS, TX, 75313-1709, US

(21) Appl. No.: 12/208,777

(22) Filed: Sep. 11, 2008

Related U.S. Application Data
(60) Provisional application No. 61/078,264, filed on Jul. 3, 2008.

(51) Int. Cl. G06Q 40/00; G06Q 50/00; G06Q 10/00

(52) U.S. Cl. 705/4; 705/3; 705/7

(57) ABSTRACT

The present invention relates generally to healthcare, and more specifically to a process for more completely and more accurately diagnosing the health condition of health insurance plan members through a comprehensive health assessment. In doing so, the method of the present invention reflects the guidelines established by various insurance payors such as the United States Centers for Medicare and Medicaid Services (“CMS”). The present invention further provides a method for monitoring follow-up member care to increase the likelihood that the quality of medical care given to plan members is increased.

### CROSS-REFERENCE TO RELATED APPLICATION

This application claims the benefit of priority from U.S. Provisional Application No. 61/078,264 filed on Jul. 3, 2008.

### FIELD OF THE INVENTION

The present invention relates generally to healthcare, and more specifically to a process for more completely and more accurately diagnosing the health condition of health insurance plan members through a comprehensive health assessment. In doing so, the method of the present invention reflects the guidelines established by various insurance payors such as the United States Centers for Medicare and Medicaid Services (“CMS”). In particular, insurance payors such as CMS may suggest that health insurance plans provide yearly screenings of their members, or that health insurance plans consider the need for additional therapy or diagnostic evaluation.

The present invention further relates to the field of improving member health care, as the comprehensive health assessment may provide a more accurate and complete picture of a given member's health. By providing data gathered in the comprehensive health assessment to a given member's physician—by way of example but not limitation, the member's primary care physician, preferred physician or treating physician—improved member care may be achieved.

Furthermore, the present invention also may provide a method for monitoring member care to improve the likelihood that the care given to the member, both prior and subsequent to the comprehensive health assessment, meets one or more then-current standards of care promulgated by one or more standards bodies. By way of example and not limitation, such standards bodies may include groups such as the National Committee for Quality Assurance (“NCQA”) which promulgates guidelines known as the Healthcare Effectiveness Data and Information Set (“HEDIS”), and CMS which promulgates a program known as the Physician Quality Reporting Initiative. In addition, physician specialty organizations may also promulgate guidelines for care specific to a particular health condition. In one or more alternate embodiments, the method of the present invention may compare care received by a member with such standards of care, and may provide recommendations or feedback to the member, the member's physician, and/or the member's health insurance plan advising of any apparent shortfalls in the member's care. Also, in one or more alternate embodiments of the present invention, the method may continue to track the member to increase the likelihood that any shortfalls in the member's care are addressed so that the member's care satisfies the appropriate guidelines.

In addition, the present invention relates to a method for processing data gathered in the comprehensive health assessment to determine a complete set of member health conditions. The method of the present invention further processes this set of determined member health conditions to derive a set of standardized codes which represent the health conditions present in the member. Such codes are thereafter recognized by one or more insurance payors, such as, but not limited to, CMS. This set of standardized codes, when received by an insurance payor, may then be used by the payor to determine appropriate payment rates to be paid to a health insurance plan as reimbursement to the health insurance plan for providing health insurance to the member represented by the set of standardized codes. For the purposes of description of the present invention, a health insurance plan may be the practitioner of the present invention. However, it should be noted that the practitioner of the present invention may be a third party, known as a third party submitter, practicing the present method for the benefit of a health insurance plan. Alternatively, the method may be used in a hybrid system, wherein a third party prepares the set of standardized codes, but then the health insurance plan submits the set of codes to the insurance payor.

The present invention further relates to the process of quality control within the insurance industry, as it also provides more accurate preparation of the set of standardized codes which represent member health conditions. By improving the accuracy of this standardized code set, the present invention may reduce the number of audit failures suffered by the practitioner of the present invention. Specifically, by improving the accuracy of the set of standardized codes, payors may identify fewer errors in a given audit of the invention practitioner's submissions to the payor.

### BACKGROUND OF THE INVENTION

The following background of the present invention will discuss generally the operation of CMS and how that organization both strives to provide up-to-date health care coverage while promoting quality care for health insurance plan members and accomplishes those goals, in part, by acting as a payor to health insurance plans. However, it should be understood that the discussion of CMS is by way of example only, and that the method of the present invention may be practiced in association with other payor entities.

In the United States, CMS administers plans known as Medicaid and Medicare, and within Medicare, a plan currently known as Medicare Advantage. Medicare Advantage operates as somewhat of a hybrid between a federally-provided health insurance plan known as Medicare Parts A and B, and a private health insurance plan as provided by health insurance plans other than Medicare. Under Medicare Advantage, health insurance plans register eligible individuals as members. CMS, through the Medicare Advantage plan, pays to a health insurance plan a dollar amount generally intended to subsidize the costs to the health insurance plan expected to be generated by a particular member, given the health conditions present in that member. In order for a health insurance plan to provide up-to-date and quality care for its members, CMS recognizes that the health insurance plan must be reimbursed for the extra costs associated with the improved care.

Of course, the amount paid to a health insurance plan by CMS will generally vary based upon a particular member's health conditions recognized in the CMS model in order to sufficiently reimburse the health insurance plan for the expenses expected to be incurred in providing health care to the particular member. Thus, CMS provides an incentive to health insurance plans to not only improve the care of their members, but also to insure members who would be otherwise uninsurable due to their health. In particular, as some health insurance plans may take the position that enrolling a member with a profile indicating some level of ill health may not be a sound financial decision given the expected costs to care for that member, CMS essentially makes such a member insurable by allocating to the health insurance plan some known level of reimbursement for both enrolling a member in poor health and improving the quality of care received by that member.

Under the current system, however, health insurance plans may not conduct systematic comprehensive health assessments of their members or have documentation of the results of systematic comprehensive health assessments of their members. Thus, members may not receive the improved care suggested by CMS. In addition, the health insurance plans may not possess effective means for ensuring that care given to their members meets one or more then-current standards of care, for example, HEDIS promulgated by NCQA or the Physician Quality Reporting Initiative promulgated by CMS. Also, the health insurance plans may not have the means for ensuring that when a deficiency in care, as measured against the one or more then-current standards of care, is revealed, that adequate steps are taken to provide such additional care.

Furthermore, some health insurance plans do not have an effective means of gathering and processing complete member health data in order to prepare accurate profiles of their members. Without the ability to gather and process such data, health insurance plans, again, may not be providing the quality of care suggested by CMS. In addition, because the health insurance plans may provide health insurance to members who, because of their health conditions, may represent added expenses, health insurance plans may be forfeiting opportunities for reimbursement from CMS to which they are entitled by not accurately gathering complete member health data.

For example, individuals with diabetes mellitus are known to experience certain attendant related health conditions associated with that disease. For example, vascular disease, which is pervasive in diabetics, may lead to lower extremity amputation or renal failure, both of which generate an expected cost associated with continuing care for the member. The CMS reimbursement model requires not only that the underlying health condition and its attendant related health conditions be specifically documented, but also that each of these health conditions be specifically re-documented each calendar year. In the event the health insurance plan insuring the member is unaware the member has diabetes mellitus and/or its attendant related health conditions, or somehow omits that data from year to year and therefore does not transmit that information to CMS, CMS will not reimburse the health insurance plan the amount due to it for both providing health insurance to that member and for providing the greater level of care for that member necessitated by the member's diabetes.

Currently, some health insurance plans rely at least to some degree on member/physician interactions to develop a member's profile of health conditions. In this system, each time a member visits a healthcare facility, the health insurance plan gathers data regarding the treatments performed by the healthcare provider during that visit. At least some treatment data is gathered and submitted to the health insurance plan by the healthcare provider as, in most systems, the healthcare provider is reimbursed by the health insurance plan for rendering treatment to the member. However, it is in this process that the fundamental disconnects between the CMS guidelines and the actual care given to the patient, as well as between the data provided by the healthcare provider and the data required by the health insurance plan to develop an accurate member profile, is revealed. Treatment of a particular symptom or single condition, without consideration of the entire health condition, does not necessarily equate to quality care for the member. Furthermore, information regarding a particular treatment does not necessarily sufficiently describe a particular health condition. Returning to the diabetes mellitus example, fitting a member with an insulin pump (common in the treatment of diabetes mellitus) is logically a strong indicator that the member is a diabetic. However, providing this piece of equipment is not a diagnosis of diabetes mellitus. Because this piece of treatment data is not an actual diagnosis, the fact that a member was fitted with an insulin pump cannot, under some sets of payor guidelines such as those promulgated by CMS, support the inclusion of the diabetic condition in the member's profile.

In addition, without a yearly comprehensive health assessment performed on the member, the likelihood that the member's care meets or exceeds then-current standards of care, such as HEDIS or the Physician Quality Reporting Initiative previously described, may drop. In addition, without means for comparing care actually given against such standards of care, and then for tracking follow up care, the health insurance plans may not be able to correct any care deficiencies.

Compounding the disconnects just described, health insurance plans are required to submit member profiles to Medicare annually. In the case of chronic conditions, there may be no need for a healthcare provider to annually note that a member has such a condition. By way of example, if a diabetic member has had an amputation, this condition is persistent and recognized as having the potential to incur an expense. The condition is, therefore, assigned a value under the CMS model, but may not cause significant health issues from year-to-year. For this reason, a health insurance plan may properly note in a given year that a member is an amputee and be reimbursed from Medicare accordingly. However, without the gathering of a complete member health profile each year, the amputation diagnosis may not be noted and may therefore be lost in any year, thereby preventing the health insurance plan from recovering a reimbursement from Medicare to which it is entitled for providing the enhanced care likely necessary for that member.

The method of the present invention addresses these deficiencies in both the complete care of a member and in the data gathering of member health profiles by both performing a comprehensive health assessment of the member and by gathering more complete member health data, including all diagnoses, and comparing that information to then-current standards of care for those diagnoses. In the event that one or more deficiencies in the member's care are identified, such deficiencies may be reported to the member's health insurance plan and/or the member's physician, and then may be tracked to raise the likelihood that the member's level of care is brought within the then-current guidelines.

The present method further comprises the proper processing of data gathered so that it may be submitted to an appropriate payor, for example CMS.

### SUMMARY OF THE INVENTION

It is an object of the present invention to improve the quality of care for members of health insurance plans by performing regular comprehensive health assessments of those members to determine the members' overall state of health and comparing those comprehensive health assessments to then-current standards of care.

It is an object of the present invention to provide a method which overcomes the problems associated with the incomplete collection of member health condition data and the attendant data processing required to accurately gather such data and to prepare it for submission to an insurance payor.

It is a further object of the present invention to gather comprehensive member health profiles.

It is a further object of the present invention to compare information from member health profiles to then-current standards of care for conditions identified therein.

It is a further object of the present invention to improve member care by providing a member's physician with the results from comprehensive health assessments of the member and/or information regarding elements of member care that may be lacking when compared to then-current standards of care.

It is a further object of the present invention to generate and process member health data in a manner which will improve accuracy in member profile submission to insurance payors.

It is a further object of the present invention to provide a method for identifying health insurance plan members who may be incompletely or inaccurately medically evaluated and subsequently performing a comprehensive health assessment of such members to ensure accurate creation and submission of member profiles to one or more insurance payors.

It is a further object of the present invention to identify certain health insurance plan members who may be members of medically high-risk groups where improved diagnosis may assist in improving member care.

It is a further object of the present invention to evaluate health insurance plan members using tools, including, but not limited to, comprehensive health assessment forms, that are specific to a particular health condition or are specific to the known health conditions of the member.

It is a further object of the present invention to provide a method for integrating member data in a computer database.

It is a further object of the present invention to provide a method for applying known payor guidelines, for example, but not limited to, Medicare Advantage Hierarchal Category Condition rules, disease interactions and diagnosis code mappings to a set of member diagnosis data.

It is a further object of the present invention to provide a method for gathering member health data and processing such data for submission to an insurance payor system, for example, but not limited to, the Medicare Risk Adjustment Processing System.

### BRIEF DESCRIPTION OF THE DRAWINGS

FIG. 1 is a flowchart depicting the steps of the present invention.

FIG. 2 is a partial view of the flowchart of FIG. 1, showing an additional step present in various alternate embodiments of the present invention.

FIG. 3 is a partial view of the flowchart of FIG. 1, showing an additional step present in various alternate embodiments of the present invention.

FIG. 4 is a partial view of the flowchart of FIG. 1, showing an additional step present in various alternate embodiments of the present invention.

### DETAILED DESCRIPTION

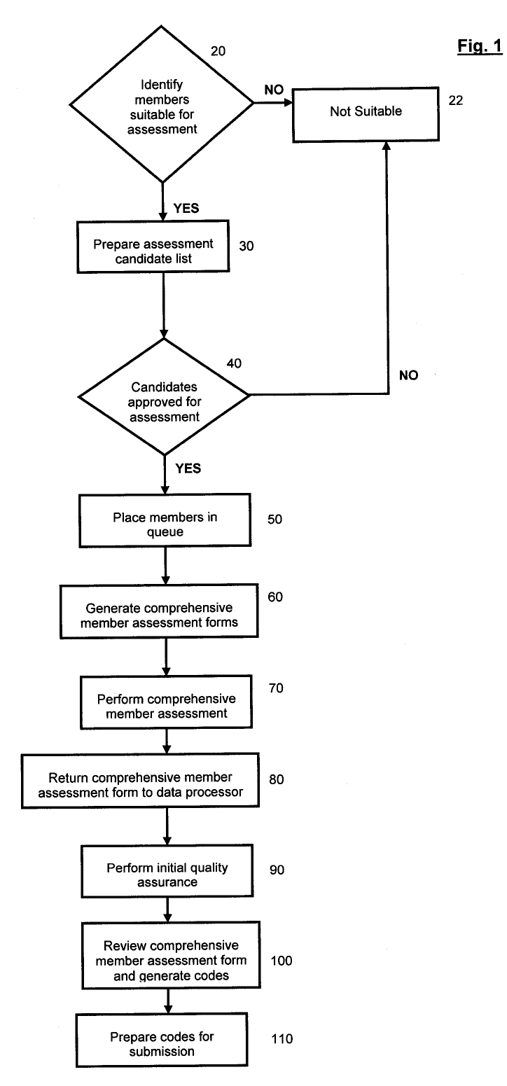

With reference to FIG. 1, the method of the present invention is a multi-step process beginning with the step 20 of identifying a set of health insurance plan members who may be suitable for comprehensive health assessment. Although ideally all members of a health insurance plan would be selected for a comprehensive health assessment, in some circumstances not all members may require such comprehensive health assessments, or the selection process may be used as a method for prioritizing those members most in need of a comprehensive health assessment.

The step 20 of identifying a set of health insurance plan members may be accomplished by a number of processes such as identifying high-risk or otherwise medically relevant member populations based on, for example, member age, sex, or medical history. Alternatively, or in conjunction with the preceding, a set of logic rules could be developed and employed utilizing some or all of these factors which would further refine the selection process. As will be appreciated by those skilled in the art, member characteristics can be used to predict the presence or absence of certain health conditions, or may indicate a need for further evaluation. In so doing, a practitioner of the present invention may identify a set of members who may be likely to have been incompletely or improperly evaluated in the past and which, therefore, may be in need of regular comprehensive health assessments, and which also may represent opportunities for the health insurance plan covering the selected individuals to correct the amount it is reimbursed by its payor, for example, CMS.

For example, a practitioner of the present invention may select a group of members known to occupy a specific age bracket; live in a specific geographic area; be employed in a specific industry; who may otherwise represent a need for comprehensive health assessment; or who may otherwise represent instances in which the health insurance plan has failed to recoup deserved reimbursements from an insurance payor. Members who are not suitable for further evaluation are returned 22 to the practitioner's pool of members. Members who are suitable for further evaluation are used to populate 30 an assessment candidate list. In step 40, the assessment candidate list may be subject to an approval decision. In the embodiment where a health insurance plan is the practitioner of the present invention, the approval decision may be an internal review to ensure that the review candidate list is accurate; that the review candidate list represents the members most in need of a comprehensive health assessment; or, since additional member review may represent added cost to the health insurance plan, the decision may involve evaluation based on the cost associated with reviewing particular members.

In an alternate embodiment of the present invention where the practitioner is a third party practicing the invention for the benefit of a health insurance plan, the approval decision step 40 may involve submission of the review candidate list to the health insurance plan for approval or rejection. In this embodiment, the health insurance plan may employ a similar review of members to assess those most in need of a comprehensive health assessment and/or the expected costs associated with the comprehensive health assessment.

Members of the review candidate list who are rejected in approval decision step 40 are returned 22 to the practitioner's pool of members. Members who are approved are placed in an assessment queue in step 50. Members in a single assessment queue are typically, but not necessarily, the responsibility of a single payor-qualified health evaluator. In various embodiments, payor-qualified health evaluators may be either employees of the practitioner, or third party vendors experienced in the task of performing comprehensive health assessments.

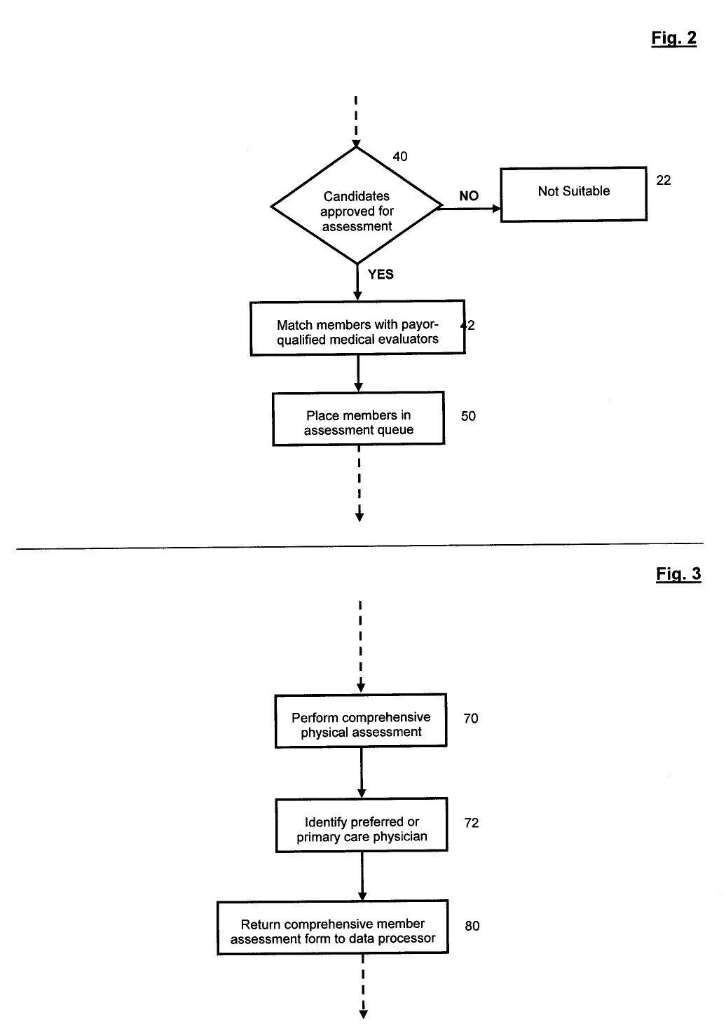

Turning momentarily to FIG. 2, in one or more alternate embodiments, the step of placing members in an assessment queue 50 may involve one or more sub-steps. For example, in step 42, members approved in step 40 may first be matched with an appropriate payor-qualified health evaluator. Therefore, in matching step 42 the practitioner of the present invention may employ any one of a number of criteria to match members with payor-qualified health evaluators, including but not limited to the immediacy of the need to perform a comprehensive health assessment, financial maximization, and/or geographic proximity to match members with payor-qualified health evaluators. Once the matching step 42 has been completed, in this alternate embodiment, the method of the present invention moves to step 50 where the members thus matched are placed in an assessment queue.

Returning to FIG. 1, in step 60, comprehensive health assessment forms are created. Comprehensive health assessment forms are tools used by payor-qualified health evaluators to assist in the organizing of member data gathered in the member's comprehensive health assessment described below. The member's comprehensive health assessment forms may be either traditional paper forms or electronic forms suitable for completion on an electronic device such as, by way of example and not limitation, a computer, personal digital assistant, or a device dedicated to and/or designed for the completion of comprehensive health assessment forms. Furthermore, the comprehensive health assessment form may be generally tailored to varying degrees to anticipate the member's eventual comprehensive health assessment. In certain embodiments, the comprehensive health assessment form may be designed to focus the attention of the payor-qualified health evaluator on certain health conditions known or suspected to be present in the member to be assessed. For example, a comprehensive health assessment form created for a member known or suspected to have diabetes mellitus may include blanks or questions crafted to diagnose the disease, if present. Such questions could, for example, search for the use of insulin, the presence of foot ulcers, and/or renal disease. Thus, while the payor-qualified health evaluator will perform a comprehensive health assessment of the member, special attention may be devoted to verifying the presence or absence of certain health conditions. By employing tailored comprehensive health assessment forms, the practitioner may increase the likelihood of creating an accurate member health profile, thereby improving the treatment and care of the member, as well as eventually formulating an accurate reimbursement to the member's health insurance plan from an insurance payor, such as CMS.

In step 70, the member's comprehensive health assessment is performed by a payor-qualified health evaluator. The member's comprehensive health assessment may generally entail a health evaluation of varying degrees of detail. For example, in the event that the practitioner of the present invention was specifically interested in confirming the presence or absence of a particular condition, the member's comprehensive health assessment may target that condition. However, in a preferred embodiment, the comprehensive health assessment will include, by way of example only, a comprehensive examination of the member; an assessment of the member's clinical history, including medications; an assessment of the member's risk factors; the member's past and current health status; the member's family medical history; an assessment of the member's activities of daily living; an assessment of the member's life-planning activities, including advance directives; a review of systems; a recommendation for selected preventive screenings; and/or health education, including anticipatory guidance.

As a part of the member's comprehensive health assessment, the payor-qualified health evaluator will also complete the comprehensive health assessment form associated with that member.

Once the member's comprehensive health assessment 70 has been completed, in step 80, the completed comprehensive health assessment form is returned to a data processor. As previously noted, in the situation where the present invention is practiced by a health insurance plan, the health insurance plan itself may act as the data processor, or it may elect to employ a third party to perform one or more of the data processing functions described below. Alternatively, in the situation where a third party, for example a third party submitter, is practicing the present invention for the benefit of a health insurance plan, the third party may act as the data processor or may also elect to employ yet another party to perform one or more of the data processing functions described below. In yet another alternative, a third party may process all the necessary data and prepare it for submission to an insurance payor, but then deliver the finished product to a health insurance plan for submission to the insurance payor.

The completed comprehensive health assessment form is returned to the data processor in any one of a number of formats, generally depending on the format of the original comprehensive health assessment form and the technology available. For example, the completed form may be transmitted digitally if the comprehensive health assessment form is in an electronic format; or, in the event of a paper comprehensive health assessment form, it may be faxed, mailed, scanned and sent electronically, or by any of a number of known means.

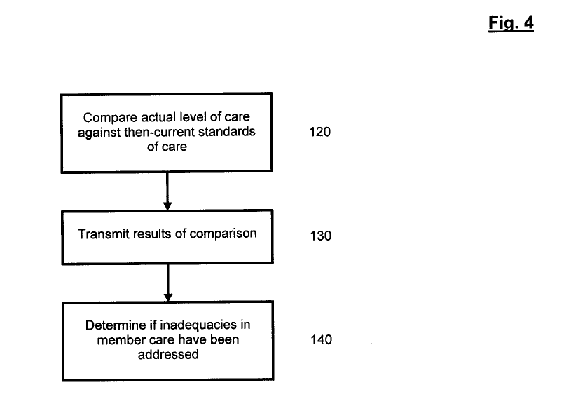

Turning momentarily to FIG. 3, in an alternate embodiment of the present invention, following the step of performing the member's comprehensive health assessment 70, the additional step 72 of identifying the member's physician may be performed. Said physician may be, by way of example and not limitation, the member's primary care physician, preferred physician or treating physician. This step will generally be employed to ensure that data gathered during the member's comprehensive health assessment is not only used in the construction of an accurate member health profile, but is also provided to the member's physician to better enable said physician to provide improved care to the member in the future. Thus, the identity of the member's physician may be included on the completed comprehensive health assessment form, which is then returned to a data processor in step 80.

Returning to FIG. 1, in step 90, an initial quality assurance step may be performed on the returned comprehensive health assessment form. In general, the goal of this step is to ensure that basic requirements are met by the returned comprehensive health assessment form. These requirements may include, by way of example only and not limitation, that the form is legible (particularly in cases where the form has been faxed or scanned), that it has been fully executed, and/or that it includes specific requirements imposed by the insurance payor. More specifically, the insurance payor may require the presence of signatures by the member and/or the payor-qualified health evaluator or may impose requirements regarding the degree to which a particular diagnosis has been explored with the member. In other words, the insurance payor may require a degree of evidence supporting a particular diagnosis, rather than a mere listing of the diagnosis. Thus, a more specific goal of step 90 is to increase the likelihood that any data gathered during the member's comprehensive health assessment step 70 will be ultimately accepted by the insurance payor.

In step 100, the completed comprehensive health assessment form is reviewed by the data processor, and a set of standardized codes is generated based on the data contained in the comprehensive health assessment form. Such standardized codes are generally established by the insurance payor and may be used to represent and convey information regarding the member's health condition to the insurance payor so that the insurance payor will reimburse the health insurance plan for insuring a member with a set of health conditions and for providing the expected level of care attendant to a member with those conditions. Upon final review of the comprehensive health assessment form, the resulting diagnosis and recommendations may be compared to then-current standards of care and may then be provided to the member and/or the member's physician, and the member's health insurance plan. Subsequent monitoring of future member procedures, prescriptions, and physician visits may occur to measure the effectiveness of the process on improving member care.

Finally, in step 110, the set of standardized codes generated in step 100 is prepared for submission and submitted to the insurance payor. Preparation of the set of codes may include a number of steps designed to increase the likelihood that the codes will be accepted by the insurance payor. Thus, these steps may include, by way of example but not limitation, formatting the codes in a manner specified by the insurance payor and ensuring that all required data is present. In a case where the insurance payor is CMS, the formatted codes are generally known as a Risk Adjustment Processing System or RAPS file.

Turning to FIG. 4, in an alternate embodiment of the present invention, additional steps relating to the comparison of actual member care against then current standards of care, as well as reporting of the results of that comparison, and finally tracking the member to increase the likelihood that the member's actual care improves may be performed. In step 120, data regarding the level of care provided to the member, which was gathered in step 70, and has been processed through steps 80, 90, and 100, may then be compared against then-current standards of care to determine if there are inadequacies in the member's care or otherwise does not meet or exceed such standards. In step 130, the results of such comparison may then be transmitted to the member, the member's physician, and/or the member's health insurance plan. Finally, in step 140, the practitioner of the present invention may employ one or more methods, such as tracking of subsequent claims data, to determine if any inadequacies in the member's care identified in step 120 have been addressed.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

1. A method for improving medical care for health insurance plan members by gathering health insurance plan member data and processing such data for submission to an insurance payor system comprising the steps of:
a) Identifying members of a health insurance plan suitable for comprehensive health assessment;
b) Populating an assessment candidate list;
c) Queuing said members for comprehensive health assessments;
d) Generating one or more comprehensive health assessment forms;
e) Performing said comprehensive health assessment of said members, including completing said comprehensive health assessment forms;
f) Returning said completed comprehensive health assessment forms to a data processor;
g) Performing a quality assurance review of said completed comprehensive health assessment forms;
h) Reviewing said completed comprehensive health assessment forms and generating standardized codes representing the health condition of said member;
i) Preparing said standardized codes for submission to said insurance payor; and
j) Submitting said standardized codes to said insurance payor.

2. The method of claim 1, further comprising the step of matching said member with an appropriate payor-qualified health evaluator.

3. The method of claim 1 further comprising the step of identifying a member's physician.

4. The method of claim 1 wherein the step of generating one or more comprehensive health assessment forms comprises generating comprehensive health assessment forms which are specific to health conditions known or suspected to be present in said member.

5. The method of claim 3 further comprising the steps of:
k) comparing data gathered during said comprehensive health assessment regarding the level of care provided to said member against then-current standards of care to determine if there are inadequacies in said member's care;
l) transmitting the results of said comparison to said member, said member's physician, and/or said health insurance plan; and
m) determining if any of said inadequacies in said member's care have been addressed.

6. A method for generating and processing health insurance plan member data in a manner which will improve accuracy in member profile submission to insurance payors comprising the steps of:
a) Identifying members of a health insurance plan suitable for assessment;
b) Populating an assessment candidate list;
c) Queuing said members for assessment;
d) Generating one or more comprehensive health assessment forms;
e) Performing a comprehensive health assessment of said member including completing said comprehensive health assessment form;
f) Returning said completed comprehensive health assessment forms to a data processor;
g) Performing a quality assurance review of said completed comprehensive health assessment forms;
h) Reviewing said completed comprehensive health assessment forms and generating standardized codes representing the health condition of said member;
i) Preparing said standardized codes for submission to said insurance payor; and
j) Submitting said standardized codes to said insurance payor.

7. The method of claim 6, further comprising the step of matching said member with an appropriate payor-qualified health evaluator.

8. The method of claim 6 further comprising the step of identifying a member's physician.

9. The method of claim 6 wherein the step of generating one or more comprehensive health assessment forms comprises generating comprehensive health assessment forms which are specific to health conditions known or suspected to be present in said member.

10. The method of claim 8 further comprising the steps of:
k) comparing data gathered during said comprehensive health assessment regarding the level of care provided to said member against then-current standards of care to determine if there are inadequacies in said member's care;
l) transmitting the results of said comparison to said member, said member's physician, and/or said health insurance plan; and
m) determining if any of said inadequacies in said member's care have been addressed.

11. A method for identifying health insurance plan members who may be incompletely or inaccurately medically evaluated and subsequently performing a comprehensive health assessment of such members to improve care for said member and to ensure accurate creation and submission of member profiles to one or more insurance payors comprising the steps of:
a) Identifying health insurance plan members suitable for assessment;
b) Populating an assessment candidate list;
c) Queuing said members for assessment;
d) Generating one or more comprehensive health assessment forms;
e) Performing a comprehensive health assessment of said members including completing said comprehensive health assessment forms;
f) Returning said completed comprehensive health assessment forms to a data processor;
g) Performing a quality assurance review of said completed comprehensive health assessment forms;
h) Reviewing said completed comprehensive health assessment forms and generating standardized codes representing the health condition of said member;
i) Preparing said standardized codes for submission to said insurance payor; and
j) Submitting said standardized codes to said insurance payor.

12. The method of claim 11, further comprising the step of matching said member with an appropriate payor-qualified health evaluator.

13. The method of claim 11 further comprising the step of identifying a member's physician.

14. The method of claim 11 wherein the step of generating one or more comprehensive health assessment forms comprises generating comprehensive health assessment forms which are specific to health conditions known or suspected to be present in said member.

15. The method of claim 13 further comprising the steps of:
k) comparing data gathered during said comprehensive health assessment regarding the level of care provided to said member against then-current standards of care to determine if there are inadequacies in said member's care;
l) transmitting the results of said comparison to said member, said member's physician, and/or said health insurance plan; and
m) determining if any of said inadequacies in said member's care have been addressed.
